(19) United States
(12) Patent Application Publication
(10) Pub. No.: US 2016/0197994 A1
(43) Pub. Date: Jul. 7, 2016

(54) STORAGE ARRAY CONFIRMATION OF USE OF A PATH

(71) Applicant: HEWLETT PACKARD ENTERPRISE DEVELPMENT LP, Houston, TX (US)

(72) Inventors: Siamak Nazari, Fremont, CA (US); Jonathan Andrew McDowell, Fremont, CA (US)

(21) Appl. No.: 14/915,896

(22) PCT Filed: Sep. 5, 2013
(86) PCT No.: PCT/US2013/058216

§ 371 Date: Mar. 1, 2016

(51) Int. Cl. H04L 29/08; H04L 12/26

(52) U.S. Cl. CPC H04L 67/1097; H04L 43/10

(57) ABSTRACT

Example embodiments relate to storage array confirmation of use of a path. A controller node of a storage array may confirm use of a path to a storage volume of the storage array. The controller node may include a command monitor to detect commands at a communication layer that is above a transport protocol layer. The commands may flow via a path from a host to the storage volume. The controller node may include a command analyzer to determine whether at least one of the commands indicates that the host has detected or is capable of using the storage volume successfully via the path. In other words, the command analyzer may determine that the path is active.

### BACKGROUND

In various computing environments, a server may access block level storage that is located external to the server. The block level storage may be part of a storage array located in a chassis that is separate from the server chassis, for example. The term block level storage may refer to a number of storage devices (e.g., hard drives) that are consolidated and presented (e.g., to servers) as a single logical storage volume. A server that connects to a storage volume may see the storage volume as though it were an individual hard drive in the server. A server (also referred to as a host) may connect to any number of storage arrays, for example, either directly or via a storage area network (SAN). A SAN may be a dedicated network that provides access to consolidated, block level storage.

### BRIEF DESCRIPTION OF THE DRAWINGS

The following detailed description references the drawings, wherein:

FIG. 1 is a block diagram of an example network setup, where storage array based confirmation use of a path may be used in such a network setup;

FIG. 2 is a block diagram of an example controller node that includes an example path confirmation module:

FIG. 3 is a flowchart of an example method for confirming use of a path; and

FIG. 4 is a block diagram of a controller node computing device for confirming use of a path.

### DETAILED DESCRIPTION

Servers/hosts may physically connect to and communicate with (e.g., regardless of whether directly or via a SAN) storage arrays using various transport protocols, for example, Fibre Channel, SSA, SAS, UAS, iSCSI, SCSI Parallel Interface or the like. This communication layer may be referred to as the “transport protocol layer.” On top of the transport protocol layer, servers/hosts may communicate using a command set for communicating with various peripheral devices. For example, the SCSI (Small Computer System Interface) command set or a similar command set may be used. This communication layer may be referred to as the “application layer” or the “command layer.”

To ensure redundancy and resiliency, a computing environment may provide a host with access to a storage array via multiple independent physical paths. The host may, if configured properly, detect that all of these paths connect to the same storage volume, and the host may make decisions about which path to use. In various situations, e.g., if a primary chosen path becomes unavailable, the host may instead make use of an alternate/redundant path. This ability for a server to communicate with the same storage volume via multiple physical paths may be referred to as “multipathing.”

As mentioned above, a host may implement “multipathing” to access a single storage volume (e.g., in a storage array) via multiple physical paths. For a host to take advantage of multipathing, the host may have to be configured properly. For example, the host may need to run multipathing software, and the multipathing software may need to be configured property. Unfortunately, it is common for host administrators to fail to configure their hosts properly, and it may not be apparent to the host administrator, at least at the time of setup, that the host is misconfigured. For example, looking at the transport layer (e.g., Fibre Channel or iSCSI), it may appear that the host is connected to the storage volume via a particular path (e.g., a newly-added, redundant path). Still, various issues (e.g., configuration issues in the host) may prevent the host from property communicating with the storage volume via that path. For example, the host may not be running any multipathing software, or the host may not be running the correct multipathing software. Alternatively, the host administrator may not have configured the multipathing software correctly to detect a new/redundant path or the administrator may not have run an appropriate re-scan to see the new/redundant path. Alternatively, the host and/or host software may simply have a bug that prevents proper detection of the new/redundant path.

Various ways of detecting that a path is configured correctly may be implemented in the host. In these situations, the host (e.g., via software and/or the host administrator) may determine which storage volumes the host can “see” via which paths, and the host may report these results to the appropriate storage arrays that include the detected storage volumes. Such reports may be reviewed by administrators of the storage arrays. An issue with these solutions is that storage arrays/array administrators are dependent upon the host/host administrator to report correctly. However, because a main reason that hosts do not communicate correctly with storage arrays is because of misconfiguration at the host, array administrators may not trust the host to report correctly. After all, proper reporting may require a properly configured communication path. Nor may arrays/array administrators want to wait for the host to report before confirming that the host is in proper communication. Additionally, host administrators may not want to install and/or configure software to perform the scanning and reporting.

Various other ways of detecting a path from a host at the storage array may only analyze the path connection at the transport layer (e.g., Fibre Channel, iSCSI, etc). For example, storage arrays may include features that detect, via transport-layer knowledge, when hosts are physically connected via a particular path. However, transport-layer knowledge is insufficient to determine whether the hosts are properly communicating with the storage volume of the storage array via the particular path, for example, whether the operating system (OS) of the host has scanned the storage volume via the particular path and/or whether the multipathing software of the host has detected the storage volume via the particular path. Various other ways of detecting a path from a host at the storage array may look for input/output (I/O) operations (e.g., reads, writes, etc.) coming from the host. However, looking for I/O operations may be insufficient in cases where the host is making no or light use of the storage volume initially or has decided to reserve the path for failover use rather than currently active use.

The present disclosure describes storage array based confirmation of successful detection and use of a path. The present disclosure describes a solution by which a storage array can determine whether a connected host has correctly detected and is capable of properly using a particular path (e.g., a newly-added, redundant path) to a storage volume of the storage array. This solution may be implemented entirely in the storage array and may require no modification to the host (e.g., to report which storage volumes/paths the host sees). In this respect, an administrator of the storage array may confirm that the host is not only visible at the transport layer, but has successfully detected and is capable of properly using the storage volume via the particular path. The storage array/administrator does not have to rely on the host to report. The present disclosure allows for a more certain determination that the host is correctly configured, and lessens the need for the array administrator and host administrator to both be involved with checking the status of connections.

The present disclosure may utilize various heuristics about expected host behavior to determine that the host has detected a path and is trying to property use it to access the storage volume. According to the present disclosure, the storage array may watch for various commands (e.g., SCSI commands) that flow at a layer above the transport protocol layer (e.g., at the command layer). Using this solution, the storage array may detect, for example, that the operating system (OS) of the host has scanned the storage volume via the particular path, and that the multipathing software of the host has detected the storage volume via the particular path and is capable of making proper use of it. This information about properly detected and used paths may be useful to the storage array in various situations, for example, when a new redundant path is added between a host and a storage volume. This information may also be used by the storage array when a particular path to a storage volume is removed (e.g., temporarily), for example, to determine first that an alternate/redundant path to the storage volume is fully working before the other path is removed.

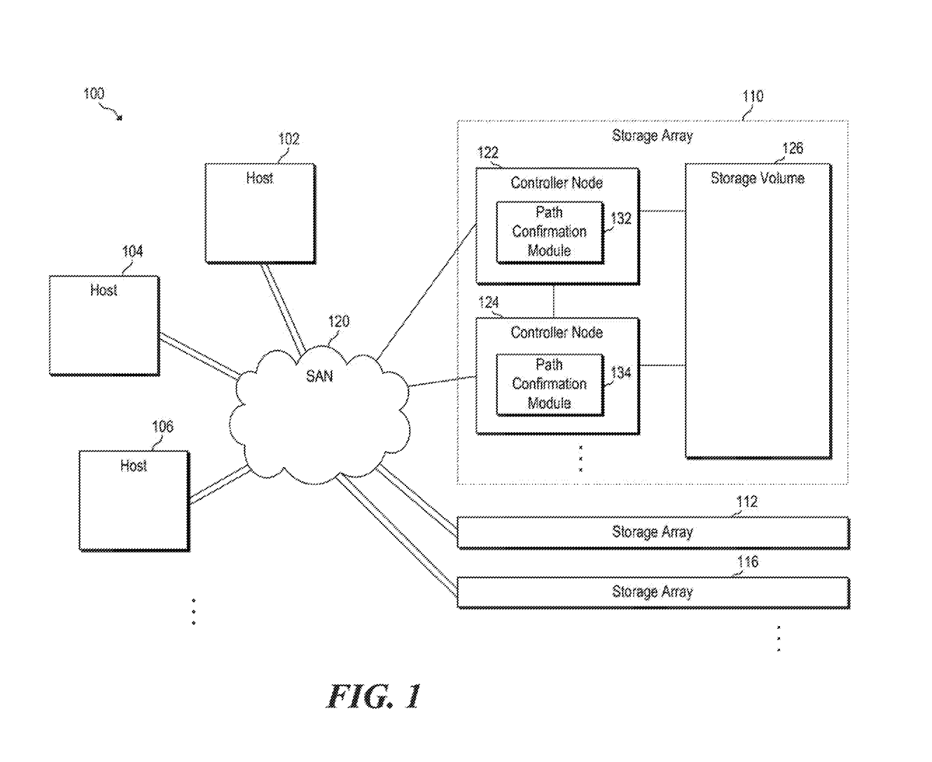

FIG. 1 is a block diagram of an example network setup 100, where storage array based confirmation of use of a path may be used in such a network setup. Network setup 100 may include at least one host (e.g., 102) connected to at least one storage array (e.g., 110), for example, via a storage area network (SAN) 120. In some examples, network setup 100 may include multiple hosts (e.g., 102, 104, 106) and/or multiple storage arrays (e.g., 110, 112, 116), where each host may be in communication with any number of the storage arrays. In some examples, the at least one host (e.g., 102) may be directly connected to the at least one storage array (e.g., 110), in which case network setup 100 may not include a SAN (e.g., 120). For ease of descriptions, the present disclosure may describe various examples that include a single host (e.g., 102) and a single storage array (e.g., 110). However, it should be understood that the various descriptions herein may apply to network setups with multiple hosts and/or multiple storage arrays.

Storage area network (SAN) 120 may be a dedicated network that facilitates access by hosts (e.g., 102, 104, 106) to consolidated, block level storage (e.g., in storage arrays 110, 112, 116). SAN 120 may include various cables, switches, routers and the like to connect various hosts to various storage arrays. In the examples where at least one host (e.g., 102) is directly connected to at least one storage array (e.g., 110), the particular host may be connected to the particular storage array without routing through SAN 120. As one specific example, if host 102 and storage array 110 are directly connected, the two connections coming from the controller nodes of storage array 110 may route directly to host 102.

Host 102 may communicate with at least one storage array (e.g., 110), for example, via SAN 120. Hosts 104 and 106 may be similar in several respects to the description of host 102 provided herein. Host 102 may be any type of computing device that is capable of connecting to and using remote storage such as storage array 110. Host 102 may be, for example, an application server, a mail server, a database server or various other types of servers. Host 102 may have more than one physical path to storage array 110, e.g., as shown in FIG. 1 (two physical connections through SAN 120). For example, each physical path may be connected to the host 102 via a dedicated port of a host bus adapter (HBA) in host 102. Each physical connection may be an independent path to storage volume 126, for example. In some examples, host 102 may be more than one computing device, for example, computing devices that are in communication with each other (e.g., via a network). In these examples, the computing devices may be separate devices, perhaps geographically separate. In these examples, one computing device of the multiple computing devices may connect to storage array 110 (e.g., via multiple paths), or more than one computing device may connect (e.g., each with its own path) to storage array 110. The term “system” may be used to refer to a computing environment that includes one computing device or more than one computing device.

Storage array 110 may communicate with at least one host (e.g., host 102), for example, via SAN 120. Storage arrays 112 and 116 may be similar in several respects to the description of storage array 110 provided herein. For example, storage arrays 112 and 116 may include similar components to those shown in storage array 110 in FIG. 1. Storage array 110 may have more than one physical connection to host 102, e.g., as shown in FIG. 1 (two physical connections through SAN 120). For example, each physical path may be associated with a different controller node (e.g., 122 or 124) of storage array 110. Each physical connection may be an independent path from host 102 to storage volume 126, for example. Storage array 110 may be differentiated from a simple storage device enclosure because storage array may have advanced functionality such as RAID, virtualization, etc.

Storage array 110 may be any storage system that contains multiple storage devices (e.g., hard drives). For example, storage array 110 may be a RAID (redundant array of independent disks) system with multiple spinning disk hard drives. As another example, storage array 110 may be a storage system with multiple optical drives or multiple tape drives. The multiple storage devices (e.g., hard drives) of storage array 110 may be consolidated and presented to servers (e.g., to host 102) as a single logical storage volume (e.g., storage volume 126). Storage volume 126 may, if the host is configured correctly, appear to host 102 as essentially a single local hard drive, even though storage volume 126 may include multiple storage devices. Host 102 may have multiple physical paths to access the same storage volume 126, for example, a first path through controller node 122, and a second path through controller node 124.

Storage array 110 may include at least one controller node (e.g., 122, 124), also referred to as a storage controller. FIG. 1 shows two controller nodes, but it should be understood that storage array 110 may include any number of controller nodes. For example, storage array 110 may include a single controller node that may handle multiple physical paths from the same host (e.g., 102). Likewise, storage array 110 may include more than two controller nodes to handle various physical paths from at least one host. A storage array may implement multiple controller nodes to perform load balancing and/or to add more redundancy to the storage array 110 and to network setup 100 in general.

Each controller node (e.g., 122, 124) may be implemented as a computing device, for example, any computing device that is capable of communicating with at least one host (e.g., 102) and with at least one storage volume (e.g., 126). In some examples, multiple controller nodes (e.g., 122 and 124) may be implemented by the same computing device, for example, where each controller node is run by a different virtual machine or application of the computing device. In general, the controller nodes (e.g., 122, 124) may monitor the state of the storage devices (e.g., hard drives) that make up the storage volume 126, and may handle requests by hosts (e.g., 102) to access the storage volume 126 via various physical paths. In the example of FIG. 1, each controller node (e.g., 122, 124) includes a path confirmation module (e.g., 132, 134).

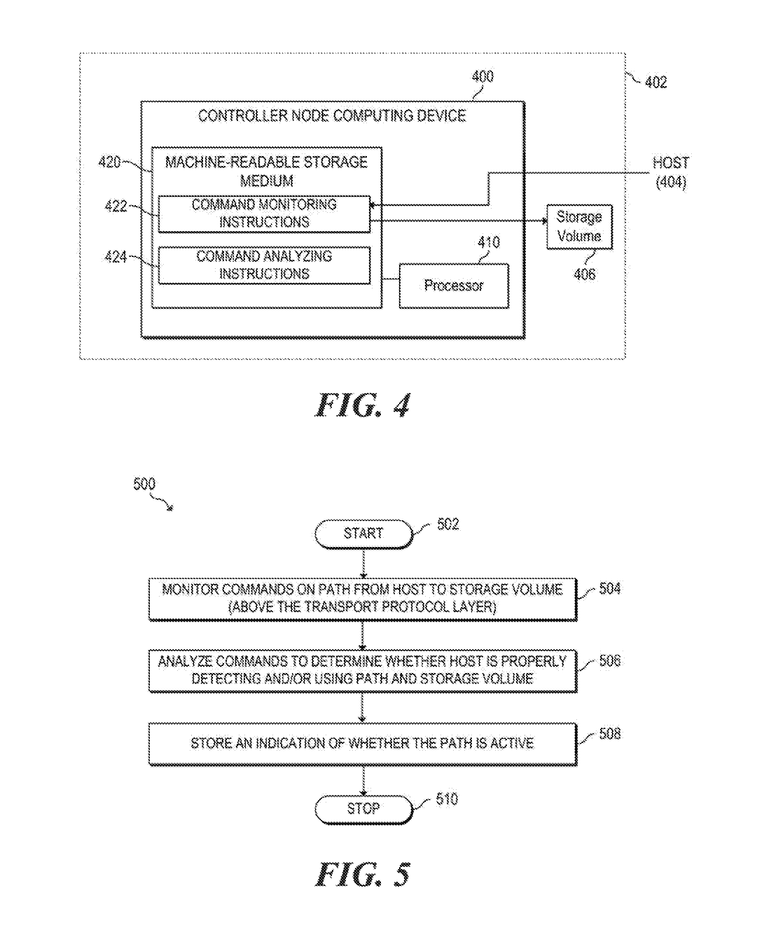

Path confirmation modules 132, 134 may each include a series of instructions encoded on a machine-readable storage medium and executable by a processor (e.g., processor 410 of FIG. 4) of the respective controller node 122 or 124. In addition or as an alternative, these modules may each include one or more hardware devices including electronic circuitry for implementing the functionality of the path confirmation module described herein.

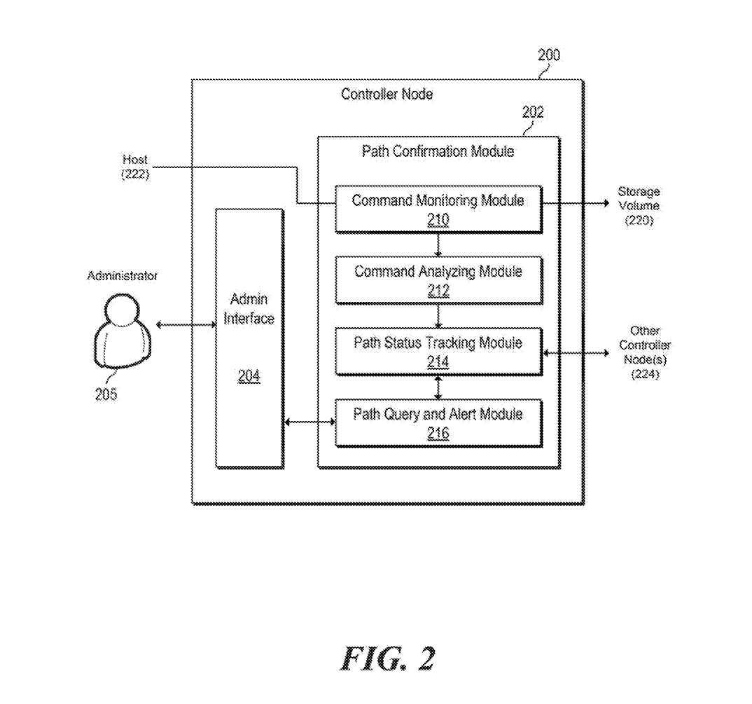

FIG. 2 is a block diagram of an example controller node 200 (e.g., similar to controller node 122 and 124 of FIG. 1) that includes an example path confirmation module 202 (e.g., similar to path confirmation module 132 and 134 of FIG. 1). Controller node 200 also includes an admin interface 204, which may allow an array administrator (e.g., 205) to view and/or configure various aspects of the storage array via controller node 200. Path confirmation module 202 may include a number of modules, for example, modules 210, 212, 214, 216. These modules may include a series of instructions encoded on a machine-readable storage medium and executable by a processor (e.g., processor 410 of FIG. 4) of controller node 200. In addition or as an alternative, these modules may include one or more hardware devices including electronic circuitry for implementing the functionality of the path confirmation module described herein.

Path confirmation module 202 may determine whether a connected host has correctly detected and is capable of property using a particular path (e.g., a newly-added, redundant path) to a storage volume 220 (e.g., similar to storage volume 126 of FIG. 1) of a storage array (e.g., 110). This information may be used by the path confirmation module 202 when a particular path to a storage volume is to be removed (e.g., temporarily), to ensure that the host will not lose connectivity to the storage volume during such removal. One example reason why a particular path to a storage volume may be removed is that an array admin may upgrade a controller node of the storage array, which may temporarily disrupt any path that routes through the controller node. In this situation, a path through a second controller node of the same storage array may stay active and may provide access to the host. Another example reason is that an administrator may replace cabling through part of a network (e.g., network setup 100), which may temporarily remove paths. Another example reason is that there may be a fault on one of the paths (e.g., due to a degraded hardware switch, cable, etc.). If an administrator (e.g., 205) knows in advance that a particular path will be removed, the administrator may query (e.g., via admin interface 204) the path confirmation module 202 to determine whether an alternate path exists for a host (e.g., 222) to the storage volume (e.g., 220).

Command monitoring module 210 (also referred to as command monitor) may monitor commands that flow from various hosts (e.g., host 222) to storage volume 220. Host 222 may be similar to host 102, for example. Module 210 may monitor commands that flow via a layer that is above or on top of the transport protocol layer. For example, module 210 may monitor commands that flow via the “application layer” or “command layer.” As mentioned above, communications at the command layer use a command set (e.g., the SCSI command set).

Command analyzing module 212 (also referred to as command analyzer) may analyze the commands that are seen (above the transport protocol layer) by command monitoring module 210. Command analyzing module 212 may detect particular commands (e.g., SCSI commands) and/or sequences of commands to determine whether the host (e.g., 222) has correctly detected and is capable of property using a particular path to a storage volume 220. If it is determined that a host (e.g., 222) has correctly detected and is capable of properly using a particular path to a storage volume 220, it may be said that the particular path is “active.” Command analyzing module 212 may watch for various commands, such as the SCSI commands shown below in Table 1 below. Table 1 lists various example commands along with a short description of each command. Some of these commands may be initiated by the OS of the host, and some may be initiated by the multipathing software of the host. In general, the commands that module 212 watches for may be commands that are commonly initiated when a host is attempting to connect to a newly added storage volume or a newly added path to a storage volume.

TABLE 1

| SCSI Command | Description |
|---|---|
| TEST UNIT | Command from OS to check if storage device |
| READY | (storage volume in this case) is responding at all |
| INQUIRY | Command from OS and/or from muitipathing |
| (page 0) | software to request basic information about the |
| | storage device (e.g., device type, manufacturer, |
| | etc.) |
| INQUIRY | Command from multipathing software that |
| (page 0x83) | request a form of device identification from the |
| | storage device - used to detect that multiple |
| | paths are all used to access the same device |
| READ CAPACITY | Command from OS to request the data capacity |
| | of the storage device |
| READ BLOCK 0 | Command from multipathing software to confirm |
| | that a path to the storage device and the |
| | storage device itself are good (performs an |
| | example read) |
| REPORT TARGET | Command from OS and/or multipathing software |
| PORT GROUPS | used to analyze multiple paths, to determine |
| | which one is best |

In the example of Table 1, each of the shown commands may provide an indication that the host has discovered and/or is property using the particular path at a layer that is above the transport layer (e.g., at the command layer). When command analyzing module 212 sees more than one of these commands, module 212 may determine with a higher degree of confidence that the host has discovered and/or is property using the particular path. In other words, each of the above commands alone may provide a positive indication, but as module 212 sees more of the above commands (e.g., in the order shown in Table 1), the likelihood increases that the host is properly connected. For example, seeing more of these commands may allow module 212 to confirm that multipathing software in the host has discovered the storage volume and is performing interrogation to determine the exact nature of the new path to the storage volume. It should be understood that the commands shown in Table 1 represent just one example of a pattern of commands that module 212 may detect. Module 212 may be capable of detecting various other heuristics and/or patterns of commands that flow at a communication layer above the transport protocol layer.

Command analyzing module 212 may at some point, while analyzing commands for a particular host and path, determine that module 212 has seen enough information to determine that the host and path are active (i.e., the host is property connected to the storage volume via the path). For example, module 212 may maintain at least one threshold, and once module 212 sees enough evidence (e.g., commands above the transport layer) to surpass the threshold, module 212 may determine that the host and path are active. Module 212 may then indicate active hosts and paths to path status tracking module 214.

Path status tracking module 214 (also referred to as path status tracker) may track and/or store the active status for various hosts/paths, e.g., both for the local controller node (e.g., 200) and for other controller nodes of the same storage array. Path status tracking module 214 may receive host/path active indications from module 212 for the local controller node. This may include active indications for paths that pass through the local controller node (e.g., 200). Module 214 may also receive host/path active indications from at least one other controller node (e.g., 224) of the same storage array. This may include active indications for paths that pass through the other controller node(s). Likewise, module 214 may send host/path active indications to at least one other controller node (e.g., 224) of the same storage array such that the other controller node can track and/or store such information. In this respect, any controller node in a storage array may maintain or have access to information about all host-to-storage-volume paths that pass through the storage array. Thus, and administrator may connect to any controller node. e.g., via admin interface 204, and determine whether a particular path through the storage array is active.

In some examples, path status tracking module 214 may be located external to path confirmation module 202, and perhaps external to controller node 200. In these examples, each storage array (e.g., 110) may include a single path status tracking module 214, and each controller node (and path confirmation module) in the storage array may have access to the status tracking module. Each path confirmation module in the storage array may send its host/path active indications to the central status tracking module, and each path confirmation module may have access to the central status tracking module, for example, to respond to path queries, which are described in more detail below.

Path query and alert module 216 may communicate with path status tracking module 214 to determine whether various hosts/paths are active. In general, module 216 may check if a particular path is active and may, in some situations, generate an alert if an important path is not active. A part of module 216 that handles queries (e.g., from an administrator) may be referred to as the path query handler. A part of module 216 that handles responses and/or alerts may be referred to as the path alert handler. As one example, an array administrator (e.g., 205) may access controller node 200 (e.g., via admin interface 204) with the intention of taking down a particular path between a host and the storage volume of the storage array. As one specific example, the administrator may intend to perform an upgrade on the particular controller node 200, which may cause paths that pass through the controller node to temporarily be removed. In this situation, administrator 205 may access module 216 to inquire about whether it is safe to take down a particular path that passes from a host through controller node 200. Module 216 may then check whether there are any alternate paths that are active between the host and the storage volume (e.g., a path through a different controller node of the same storage array). If an alternate path is available and active, module 216 may essentially send the administrator a green light to take down the path through controller node 200, and the administrator may be confident that the host will not experience any disruption in service. If no alternate path is active, module 216 may send the administrator an alert that removing the path may cause a disruption of service.

In some examples, path query and alert module 216 may continuously or occasionally monitor the status of various paths (e.g., by communicating with module 214) and may alert an administrator of any issues, e.g., without the administrator having to query module 216. For example, module 216 may ensure that at all times any host that communicates with the storage volume of the storage array has two independent active paths to the storage volume. In this example, if at any time, module 216 detects that a host has dropped down to a single active path or no active paths, module 216 may alert the array administrator (e.g., via email, SMS, etc.). Thus, if, for example, an administrator is performing maintenance on a portion of a storage network (e.g., SAN 120), and accidentally removes a path between a host and a storage volume, at least one controller node of the associated storage array may alert the administrator.

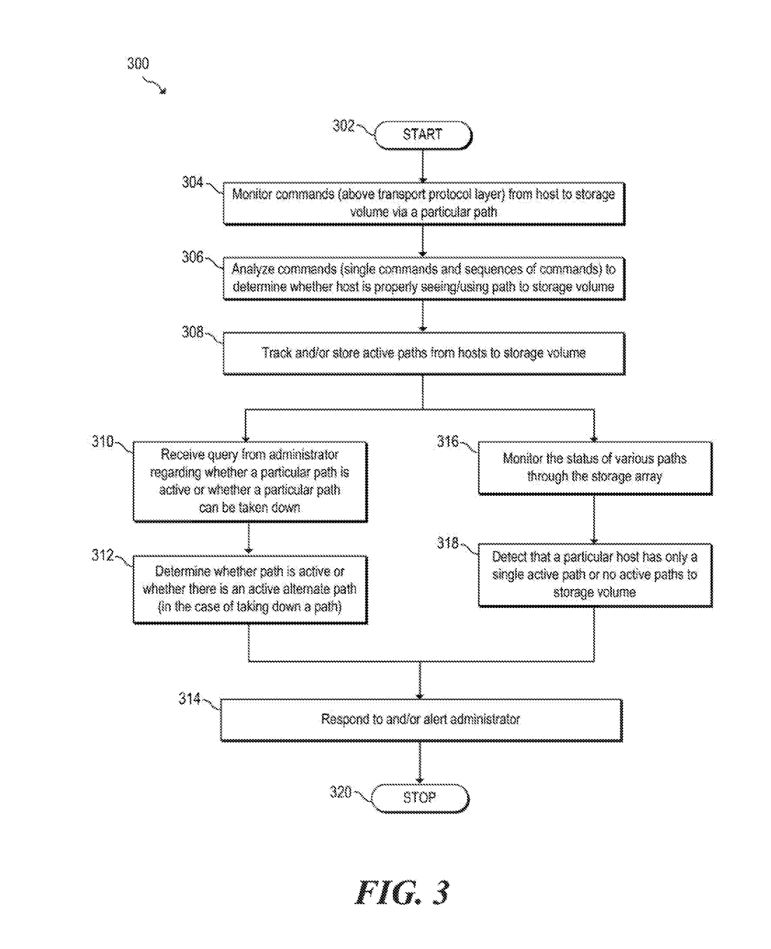

FIG. 3 is a flowchart of an example method 300 for confirming use of a path. The execution of method 300 is described below with reference to a controller node, which may be similar to controller node 132 or 134, for example. Various other suitable computing devices may execute method 300, for example, controller node computing device 400 of FIG. 4. Method 300 may be implemented in the form of executable instructions stored on a machine-readable storage medium, such as storage medium 420, and/or in the form of electronic circuitry. In alternate embodiments of the present disclosure, one or more blocks of method 300 may be executed substantially concurrently or in a different order than shown in FIG. 3. In alternate embodiments of the present disclosure, method 300 may include more or less blocks than are shown in FIG. 3. In some embodiments, one or more of the blocks of method 300 may, at certain times, be ongoing and/or may repeat.

Method 300 may start at block 302 and continue to block 304, where a controller node (e.g., 122) of a storage array (e.g., 110) may monitor (e.g., via module 210) commands (e.g., commands that flow above the transport protocol layer) that flow via a particular path from a host to a storage volume of the storage array. At block 306, the controller node may analyze (e.g., via module 212) the commands (e.g., single commands and/or sequences of commands) to determine whether the host is properly seeing and using the path to the storage volume. At block 308, the controller node may track and/or store (e.g., via module 214) active paths from various hosts to the storage volume, including the particular path mentioned above. In some examples, the tracking and storing of active paths may be done outside of the controller node, e.g., in a tracking and storing module that is central to the storage array and accessible to all controller nodes of the storage array, as described in more detail above.

At block 310, the controller node may receive (e.g., via module 216) a query from an administrator (e.g., 205) regarding whether a particular path is active or whether a particular path can be taken down (e.g., while still having an active alternate path). At block 312, the controller node may determine whether the particular path is active or whether there is an active alternate path (in the case of taking down a path). To perform block 312, module 216 may communicate with path status tracking module 214, for example. At block 314, the controller node may respond to and/or alert (e.g., via module 216) the administrator, for example, to confirm that a path/alternate path is active, or to warn that a path/alternate path is not active. Method 300 may eventually continue to block 320, where method 300 may stop.

At block 316, the controller node may monitor (e.g., via module 216) the status of various paths through the storage array, for example, automatically, without any queries from an administrator. At block 318, the controller node may detect (e.g., via module 216) that a particular host has only a single active path or no active paths to the storage volume. At block 314, the controller node may alert (e.g., via email, SMS, etc.) an administrator regarding the fact that a particular host has only a single active path or no active paths to the storage volume. Method 300 may eventually continue to block 320, where method 300 may stop.

FIG. 4 is a block diagram of an example controller node computing device 400 for confirming use of a path. Controller node computing device 400 may be part of a storage array 402. Controller node computing device 400 may be any computing device that is capable of communicating with at least one host (e.g., 404) and with at least one storage volume (e.g., 406) of the storage array 402. More details regarding various controller nodes may be described above, for example, with respect to controller nodes 122 and 124 of FIG. 1. In the embodiment of FIG. 4, controller node computing device 400 includes a processor 410 and a machine-readable storage medium 420.

Processor 410 may be one or more central processing units (CPUs), microprocessors, and/or other hardware devices suitable for retrieval and execution of instructions stored in machine-readable storage medium 420. In the particular embodiment shown in FIG. 4, processor 410 may fetch, decode, and execute instructions 422 and 424 to confirm successful detection and use of a path. As an alternative or in addition to retrieving and executing instructions, processor 410 may include one or more electronic circuits comprising a number of electronic components for performing the functionality of one or more of instructions in machine-readable storage medium 420. With respect to the executable instruction representations (e.g., boxes) described and shown herein, it should be understood that part or all of the executable instructions and/or electronic circuits included within one box may, in alternate embodiments, be included in a different box shown in the figures or in a different box not shown.

Machine-readable storage medium 420 may be any electronic, magnetic, optical, or other physical storage device that stores executable instructions. Thus, machine-readable storage medium 420 may be, for example. Random Access Memory (RAM), an Electrically-Erasable Programmable Read-Only Memory (EEPROM), a storage drive, an optical disc, and the like. Machine-readable storage medium 420 may be disposed within host computing device 400, as shown in FIG. 4. In this situation, the executable instructions may be “installed” on the device 400. Alternatively, machine-readable storage medium 420 may be a portable (e.g., external) storage medium, for example, that allows stage computing device 400 to remotely execute the instructions or download the Instructions from the storage medium. In this situation, the executable instructions may be part of an “installation package”. As described herein, machine-readable storage medium 420 may be encoded with executable instructions for confirming successful detection and use of a path.

Command monitoring instructions 422 may detect commands at a communication layer that is above a transport protocol layer. The commands flow via a path from a host to the storage volume. Command analyzing instructions 424 may determine whether at least one of the commands indicates that the host has detected or is capable of using the storage volume successfully via the path. This may mean that the path is “active.”

FIG. 5 is a flowchart of an example method 500 for confirming use of a path. Method 500 may be described below as being executed or performed by controller node computing device 400; however, other suitable computing devices may be used as well, for example, controller nodes 122, 124 of FIG. 1. Method 500 may be implemented in the form of executable instructions stored on a machine-readable storage medium, such as storage medium 420, and/or in the form of electronic circuitry. In alternate embodiments of the present disclosure, one or more blocks of method 500 may be executed substantially concurrently or in a different order than shown in FIG. 5. In alternate embodiments of the present disclosure, method 500 may include more or less blocks than are shown in FIG. 5. In some embodiments, one or more of the blocks of method 500 may, at certain times, be ongoing and/or may repeat.

Method 500 may start at block 502 and continue to block 504, where controller node computing device 400 may monitor commands that flow via a path from a host to the storage volume. The commands may flow at a communication layer that is above a transport protocol layer. At block 506, controller node computing device 400 may determine whether at least one of the commands indicates that the host has detected or is capable of using the storage volume successfully via the path. This may mean that the path is “active.” At block 508, controller node computing device 400 may store an indication of whether the path is active or not. Method 500 may eventually continue to block 510, where method 500 may stop.

1. A controller node of a storage array for confirming use of a path to a storage volume of the storage array, the controller node comprising:
a command monitor to detect commands at a communication layer that is above a transport protocol layer, wherein the commands flow via a path from a host to the storage volume; and
a command analyzer to determine whether at least one of the commands indicates that the host has detected or is capable of using the storage volume successfully via the path, to determine that the path is active.

2. The controller node of claim 1, wherein the command analyzer sends an indication of whether the path is active to a path status tracker of the storage array, wherein the path status tracker maintains a status of whether the path is active or not.

3. The controller node of claim 2, wherein the path status tracker is located inside the controller node.

4. The controller node of claim 2, further comprising a path query handler that communicates with the path status tracker to provide the status of whether the path is active or not upon request.

5. The controller node of claim 2, further comprising a path alert handler that communicates with the path status tracker and provide an alert if the status indicates that the path is not active.

6. The controller node of claim 1, wherein the host is connected to the storage array via a storage area network (SAN).

7. A method executed in a storage array for confirming use of a path to a storage volume of the storage array, the method comprising:
monitoring commands that flow via a path from a host to the storage volume, wherein the commands flow at a communication layer that is above a transport protocol layer;
determining whether at least one of the commands indicates that the host has detected or is capable of using the storage volume successfully via the path, to determine that the path is active; and
storing an indication of whether the path is active or not.

8. The method of claim 7, wherein the determining includes recognizing a sequence of commands that are commonly initiated by a host to discover a newly added storage volume or a newly added path to a storage volume.

9. The method of claim 7, further comprising:
receiving a query from an administrator regarding whether the path is active or whether a different path from the host can be taken down such that the path remains as an alternate path from the host to the storage volume; and
responding to the administrator regarding whether the path is active.

10. The method of claim 7, further comprising:
storing an indication of whether at least one other path from the host to the storage volume is active or not;
detecting when less than two paths from the host to the storage volume are active; and
alerting an administrator regarding the less than two paths.

11. A machine-readable storage medium encoded with instructions executable by a processor of a storage array for confirming use of a path to a storage volume of the storage array, the machine-readable storage medium comprising:
command monitoring instructions to detect commands at a communication layer that is above a transport protocol layer, where the commands flow via a path from a host to the storage volume; and
command analyzing instructions to determine whether at least one of the commands indicates that the host has detected or is capable of using the storage volume successfully via the path, to determine that the path is active.

12. The machine-readable storage medium of claim 11, further comprising path status tracking instructions to maintain a status of whether the path is active or not and to maintain an indication of whether at least one other path from the host to the storage volume is active or not.

13. The machine-readable storage medium of claim 12, further comprising path query handling instructions that communicate with the path status tracking instructions to provide the status of whether the path is active or not.

14. The machine-readable storage medium of claim 13, wherein the status of whether the path is active or not is provided in response to an indication that the at least one other path from the host to the storage volume is to be taken down.

15. The machine-readable storage medium of claim 11, wherein the command analyzing instructions are to recognize a sequence of commands that are commonly initiated by a host to discover a newly added storage volume or a newly added path to a storage volume.
